(19) United States
(12) Patent Application Publication
(10) Pub. No.: US 2019/0000096 A1
(43) Pub. Date: Jan. 3, 2019

(54) METHOD FOR PRESERVING RAW MEAT

(71) Applicant: YUGENKAISHA NIKUNO-MARUKATSU, Kagoshima (JP)

(72) Inventor: Katsuhiro SHINOHARA, Kagoshima (JP)

(21) Appl. No.: 16/110,826

(22) Filed: Aug. 23, 2018

Related U.S. Application Data
(63) Continuation of application No. PCT/JP2017/031084, filed on Aug. 30, 2017.

(30) Foreign Application Priority Data
Nov. 18, 2016 (JP) 2016-225368

(51) Int. Cl. A23B 4/005; A23B 4/06

(52) U.S. Cl. CPC A23B 4/0056; A23V 2002/00; A23B 4/06

(57) ABSTRACT

Provided is a method for preserving raw meat, whereby the raw meat can be preserved in a state where meat juice, savory taste, and moisture are retained in the meat itself, while being moderately sterilized. By heating vacuum-packaged raw meat at a temperature higher than 60 degrees Celsius and not higher than 65 degrees Celsius so as to surely avoid reaching a coagulation temperature of protein; further heating the raw meat for 1 hour to 1 hour and 15 minutes at a temperature condition of higher than 60 degrees Celsius and not higher than 65 degrees Celsius after the core temperature of the meat has exceeded 60 degrees Celsius; and, after the further heating has been completed, rapidly cooling the meat so that the meat does not freeze, and lowering the core temperature of the meat to 4 degrees Celsius or less, the raw meat can be preserved in a state in which meat juice, savory taste, and moisture are retained in the meat itself, while being moderately sterilized, and the preserved meat can be used as an alternative to raw meat.

### CROSS-REFERENCE TO RELATED APPLICATIONS

This application is a continuation application of PCT Application No. PCT/JP2017/031084, filed Aug. 30, 2017, which claims priority to Japanese Patent Application No. 2016-225368, filed Nov. 18, 2016, the entire contents of which are incorporated by reference in its entirety.

### BACKGROUND OF THE INVENTION

### 1. Field of the Invention

The present invention relates to a method for preserving raw meat, muscle fibers or the like of the raw meat having been removed from dressed carcass.

### 2. Description of the Related Art

Meat and poultries are known as meat food material used for cooking, the meat food material richly containing nutrients, such as protein, lipid, inorganic material, and vitamins, or the like, the meat including: cattle; swine; horses; goats; sheep; reindeers; buffaloes; yaks; or the like, the poultries including: fowls; ducks; turkeys; guinea fowls; or the like.

The meat is produced by: dividing dressed carcass from meat of slaughtered animals mentioned above; and removing muscle fibers or the like from the divided dressed carcass. The meat is supplied to consumers as either raw meat or meat frozen from the raw meat. Herein, since not little germs are adhered on the surface of the meat, the germs breed as time goes by, and the freshness thereof falls.

In view of the above, a method for maintaining the freshness of the meat is proposed in Reference 1, for example.

The method proposed in Reference 1 includes: irradiating ultraviolet rays to a package body wherein raw meat is vacuum-packed by means of film package; and immediately after that, placing the package body into high-temperature atmosphere of 70-92 degrees Celsius for heat-shrinking and sterilization of the material of the film package.

Reference 1: Japanese patent application Laid-open No. Heisei 10-327747

### OBJECTS AND SUMMARY OF THE INVENTION

According to the method recited in Reference 1, however, since not the inside of the meat but only the surface of the meat is sterilized by irradiating the ultraviolet rays, there is possibility that bacterium still remains.

Placing the meat within high-temperature atmosphere of 70-92 degrees Celsius after having irradiated the ultraviolet rays causes the quality of the meat to become hard. This is because protein of the meat is solidified and moisture of the same is also separated.

Accordingly, upon taking out the raw meat from the package body, the meat juice, savory taste ingredients, and moisture remaining within the package body are discarded as they are. When the raw meat is heated, the meat is too much burned to be dry and to lack the taste and/or the palate feeling thereof.

In view of the above, it is an object of the present invention to provide a method for preserving raw meat that performs moderate sterilization onto the raw meat and that can preserve the raw meat under a condition where the raw meat itself retains the meat juice, the savory taste, and the moisture thereof.

A method for preserving raw meat according to the present invention, comprises: heating vacuum-packed raw meat at a temperature higher than 60 degrees Celsius and not higher than 65 degrees Celsius so as to surely avoid reaching a coagulation temperature of protein; further heating the raw meat for 1 hour to 1 hour and 15 minutes at a temperature condition of higher than 60 degrees Celsius and not higher than 65 degrees Celsius after a core temperature of the meat has exceeded 60 degrees Celsius; after the further heating has been completed, rapidly cooling the meat so that the meat does not freeze; and lowering the core temperature of the meat to 4 degrees Celsius or lower.

Raw meat of the target of the present invention includes meats including: cattle; swine; horses; goats; sheep; reindeers; buffaloes; yaks; or the like, and poultries including: fowls; ducks; turkeys; guinea fowls; or the like supplied to be eaten by human beings. The raw meat is produced by removing muscle fibers or the like from divided dressed carcass.

Preferably, the method of preservation and treatment according to the present invention includes processing a block (lump) of raw meat (1 kg through 2 kg through 4 kg through several kg through several tens kg) in a state where general consumers cannot handle.

The method for preserving raw meat of the present invention includes: vacuum-packing the block of the raw meat by means of film packaging material, for example; and then heating the block at a low temperature.

That is, the method includes: putting the block meat into a sealed bag to be vacuum-packed; and heating the vacuum-packed raw meat for about 1 hour and 15 minutes at a temperature higher than 60 degrees Celsius and not higher than 65 degrees Celsius by means of steam or a water bath.

It is also possible to use separately the steam and/or the water bath for heating the meat while taking the size and/or the thickness of the meat into consideration.

All of bacterium (such as Salmonella bacterium, Vibrio parahemolyticus, Campylobacter, Staphylococcus aureus, or the like) adhered on the meat are not killed at a heating temperature of 60 degrees Celsius or less. It is, however, experimentally confirmed that adhesion of bacterium can be effectively hindered according to the above-mentioned temperature conditions and heating time.

If the heating time is about 1 hour through 1 hour and 15 minutes, the meat juice, savory taste ingredients, and softness of the meat can be effectively retained.

On the contrary, if the heating temperature is 65 degrees Celsius or more, the moisture comes out from the meat, meat fibers begin to harden, and also the savory taste ingredients and meat juice are separated and flow out from the meat.

The temperature should be higher than 60 degrees Celsius and not higher than 65 degrees Celsius in order to be capable of confining the meat juice, savory taste, and moisture within the meat.

It is more preferable to heat the meat at a temperature higher than 60 degrees Celsius and not higher than 63 degrees Celsius considering errors between a temperature set up for the machine and an actual temperature.

It is preferable, after a core temperature has exceeded 60 degrees Celsius, to heat the meat for about 1 hour through 1 hour and 15 minutes.

After having set a core thermometer measuring the core temperature of the meat, the change of the core temperature of the meat is monitored. When the core temperature has exceeded 60 degrees Celsius after the start of the heating, it is preferable to maintain the heating under conditions of a temperature higher than 60 degrees Celsius and not higher than 65 degrees Celsius for about 1 hour through 1 hour and 15 minutes.

At this time, it is preferable to perform machine setup upon setting the heating temperature to be the temperature higher than 60 degrees Celsius and not higher than 65 degrees Celsius.

When the core temperature has exceeded 60 degrees Celsius while measuring the same, it is preferable to further heat the meat for about 1 hour through 1 hour and 15 minutes.

In this way, the heating causes the temperature of the meat to gradually increase up to the set temperature higher than 60 degrees Celsius and not higher than 65 degrees Celsius to surely avoid reaching a coagulation temperature of protein, thereby making the meat itself retain the meat juice, savory taste ingredients, and moisture thereof.

In addition, since heating is performed at 65 degrees Celsius or less, there is no solidification of meat fibers to obtain smooth finish feeling of a rare state.

After the heating has been completed, rapidly cooling is performed onto the meat so that the meat is not frozen. It is preferable that the core temperature of the meat is 4 degrees Celsius or less, more preferably 3 degrees Celsius or less.

It is preferable that the rapidly cooling is performed by cooling the meat to 4 through 0 degrees Celsius by means of ice water or the like.

Herein, attention should be paid so as not to freeze the meat.

If the meat is frozen, cell membranes of the meat are destroyed to generate drip, resulting in palate feeling of the meat being changed.

Alternatively, after the heating has been completed, the packing may be opened once. The meat may be washed with water, and may be vacuum-packed again. After that, the meat may be rapidly cooled. Due to this, smell of the meat does not remain, and palate feeling of the meat becomes better.

In this way, the meat processed by means of the preserving method of the present invention is refrigerated.

After that, at a butcher or the like, the meat is cut according to usage thereof with a kitchen knife and/or a slicer into pieces, and the pieces are dished up on a food package, a meat tray or the like, and are packed with wrap to be sold as merchandise. The processed meat according to the preserving method according to the present invention can be cut and divided to be suitably used as sliced meat, steak meat, roast meat, cut meat or the like.

In the preserving method of the present invention, the meat is sealed in a vacuum state, some amount of meat juice, savory taste ingredients, and moistures come out to be closed within the package. Therefore, a firm and soft palate feeling, and juicy and elastic cut-able feeling are maintained.

Since the meat is sterilized, it is sanitarily excellent upon being cooked.

In addition, the meat can be used in comfort when heating it for cooking, because it has been heated up to the core thereof.

The meat having processed according to the present invention colors red almost comparably to the true color of raw meat, and can keep an appearance capable of whetting appetite upon being spread the table with dishes after having cooked.

### Effect of Invention

According to the method for preserving raw meat of the present invention, while moderate sterilization is performed thereupon, an alternative of raw meat can be obtained. The alternative can in itself retain the meat juice, savory taste, and moisture of the raw meat.

When the alternative is heated and cooked on the table or the like, the alternative can retain soft palate feeling and juicy feeling, and color red peculiar to the meat. Furthermore, a yield can be improved because of retaining the meat juice and moisture, and work of cooking the same can be also simplified.

### DETAILED DESCRIPTION OF THE PREFERRED EMBODIMENTS

Next, the present invention will now be more concretely explained while showing some Embodiments. Needless to say, the scope of the present invention is never limited to the Embodiments themselves.

### Embodiment 1

With respect to steam convection (model: SCOS-1010 RY-R, manufactured by Nichiwa Electric Corporation), a machine temperature has been set up to be 63 degrees Celsius (steam-mode: 100%), and a core temperature has been set up to be 60 degrees Celsius. As meat blocks of raw meat, 250 g of chicken thighs, 2 kg of pork meat, and 4 kg of pork meat, each of which has been vacuum-packed, have been thrown in the steam convection, respectively.

Table 1 shows results of measured time from a start time when a core thermometer provided with the steam convection indicates 60 degrees Celsius to an end time when the convection automatically stops heating.

In addition, when the machine automatically stops, the meat blocks have been taken out therefrom, and core temperatures at several points of the blocks have been measured by means of an exclusive core thermometer. If unevenness of temperature exists, further heating and measurement at the several points by means of the core thermometer have been repeated. And finally, it has been confirmed that unevenness of core temperatures has not existed.

Table 2 shows heating time until the unevenness of temperatures has not existed.

After that, the meat blocks have been soaked into 0 degrees Celsius of ice water, and the core temperatures thereof have been measured while further measuring time.

Table 3 shows time from when the meat blocks has begun to be cooled with the 0 degrees Celsius of ice water until the core temperature has become to be 3 degrees Celsius or less.

TABLE 1

| Core Temp 60° C. | Time (minutes) |
|---|---|
| Chicken thighs 250 g | 35 |
| Pork 2 kg | 200 |
| Pork 4 kg | 430 |

TABLE 2

| | time until no unevenness exists (minutes) |
|---|---|
| Chicken thighs 250 g | 30 |
| Pork 2 kg | 75 |
| Pork 4 kg | 70 |

TABLE 3

| | time until temp <=3° C. |
|---|---|
| | cooled with ice water |
| Chicken thighs 250 g | 60 |
| Pork 2 kg | 262 |
| Pork 4 kg | 310 |

The present invention includes: heating a block (lump) of raw meat at a low temperature higher than 60 degrees Celsius and not higher than 65 degrees Celsius. The size and weight of the raw meat broadly differ according to the respective portion and kind of an animal.

Therefore, even if the core temperature has reached to be 60 degrees Celsius, unevenness of temperatures may exist. As shown in Table 2, the longest time until the unevenness of temperatures has not existed has been 75 minutes (1 hour and 15 minutes) with respect to the 2 kg of pork meat. On the other hand, the shortest time of the same has been 30 minutes with respect to the 250 g of chicken thighs.

In general, it cannot be said that all of the bacterium within the raw meat are killed and the raw meat is safe after heating for 30 minutes. Especially with respect to 1 kg or more of raw meat, unevenness of temperatures may easily exist even if the core temperature thereof has reached to be 60 degrees Celsius. Accordingly, 1 hour through 1 hour and 15 minutes of heating time is required in order to remove the unevenness.

Also in rapidly cooling after the heating has been completed, the size and weight of the raw meat broadly differ according to the respective portion and kind of an animal. So, the general cooling time cannot be set up as shown in Table 3.

Therefore, it has been set up to preserve the meat in a state where propagation of bacterium is hindered by rapidly as soon as possible cooling the meat to 4 degrees Celsius or less under conditions that the meat is not frozen.

Next, functional tests of the meat processed by the preserving method according to the present invention have been made.

### Embodiment 2

With respect to the steam convection, a machine temperature has been set up to be 63 degrees Celsius, and a core temperature has been set up to be 60 degrees Celsius. As meat blocks of raw meat, 2 kg of beef meat, pork meat, and chicken breast, each of which has been vacuum-packed, have been thrown in the steam convection, respectively. Heating the meat for 1 hour after the core temperature has exceeded 60 degrees is maintained, the meat has been cooled 4 degrees Celsius or less with ice water, and after that, the cooled meat has been preserved within a refrigerator.

Herein, the meat has been processed by independent steps according to the kind of the meat, respectively.

The details of the used devices are as follows:

(1) Steam convection: Nichiwa Electric Corporation (model: SCOS-1010 RY-R);

(2) Vacuum device: Nichiwa Electric Corporation (model: LYNX42);

(3) Vacuum device: TOSEI CORPORATION (model: V400);

(4) Vacuum packaging material: Fukusuke Kogyo Co., Ltd. (standard: nylon poly; NO22, NO16);

(5) Vacuum packaging material: MICS CHEMICAL CO LTD. (standard: triple nylon standard bag: NY-5); and

(6) Core thermometer: A device attached with the above steam convection.

### [Evaluation]

Raw meat processed according to Embodiment 2 has been preserved for one day within the refrigerator. The preserved raw meat has been cut into pieces according to the usage thereof, and the cut pieces have been dished and wrapped to produce package merchandise. Ten monitors have used the merchandise for cooking, thereby obtaining the following results of functional evaluation with respect to: savory taste; softness; elastic cut-able feeling; and juicy feeling, respectively. The numerals show a number of answers saying that this is the best.

As Comparative Examples, evaluation has been made with respect to 2 hours heating, 3 hours heating, and raw meat, respectively.

TABLE 4
RE: savory taste

| | beef loin for | beef loin for | pork loin for | pork loin for | chicken breast | chiken breast |
|---|---|---|---|---|---|---|
| savory taste | steak | Syabusyabu | steak | Syabusyabu | for cutlet | for Mizutaki |
| 1 hr heated | 8 | 7 | 9 | 6 | 7 | 6 |
| 2 hr heated | 1 | 2 | 1 | 2 | 1 | 3 |
| 3 hr heated | 0 | 1 | 0 | 2 | 1 | 1 |
| raw meat | 1 | 0 | 0 | 0 | 1 | 0 |

TABLE 5
RE: softness

| | beef loin for | beef loin for | pork loin for | pork loin for | chicken breast | chiken breast |
|---|---|---|---|---|---|---|
| savory taste | steak | Syabusyabu | steak | Syabusyabu | for cutlet | for Mizutaki |
| 1 hr heated | 8 | 7 | 10 | 8 | 6 | 6 |
| 2 hr heated | 0 | 1 | 0 | 1 | 2 | 1 |
| 3 hr heated | 0 | 1 | 0 | 0 | 0 | 0 |
| raw meat | 2 | 1 | 0 | 1 | 1 | 2 |

TABLE 6
RE: elastic cut-able feeling

| | beef loin for | beef loin for | pork loin for | pork loin for | chicken breast | chiken breast |
|---|---|---|---|---|---|---|
| savory taste | steak | Syabusyabu | steak | Syabusyabu | for cutlet | for Mizutaki |
| 1 hr heated | 7 | 7 | 9 | 6 | 8 | 7 |
| 2 hr heated | 1 | 1 | 1 | 2 | 1 | 1 |
| 3 hr heated | 0 | 0 | 0 | 0 | 0 | 1 |
| raw meat | 2 | 1 | 0 | 1 | 1 | 2 |

TABLE 7
RE: juicy feeling

| | beef loin for | beef loin for | pork loin for | pork loin for | chicken breast | chiken breast |
|---|---|---|---|---|---|---|
| savory taste | steak | Syabusyabu | steak | Syabusyabu | for cutlet | for Mizutaki |
| 1 hr heated | 7 | 7 | 9 | 6 | 8 | 7 |
| 2 hr heated | 1 | 1 | 1 | 2 | 1 | 1 |
| 3 hr heated | 0 | 0 | 0 | 0 | 0 | 1 |
| raw meat | 2 | 1 | 0 | 1 | 1 | 2 |

Comparing with evaluation of 2 hours or more heating, evaluation of 1 hour heating has been remarkably better in every item including: savory taste; softness; elastic cut-able feeling; and juicy feeling.

### [Bacteriological Examination]

Raw meat (beef meat, pork meat, and chicken meat) has been processed by the method for preserving raw meat according to the present invention, which includes: vacuum-packaging; heating; and cooling with ice water. The processed raw meat has been preserved for 3 days within a refrigerator. And then, bacteriological examination has been performed onto the preserved and processed raw meat. The result of the bacteriological examination will now be recited in the followings. The examination organization has been Shokuhin Biseibutsu Center Co., Ltd. Each value in the following Tables exists within a range of 1.0*10⁴ or less wherein safe criterion requirements are satisfied.

TABLE 8
general bacterium (1 g of CFU)

| general bacterium | Japanese | Japanese | Japanese |
|---|---|---|---|
| (1 g of CFU) | beef | pork | chicken |
| 1 hr heated | less than 300 | less than 300 | less than 300 |
| 2 hr heated | less than 300 | less than 300 | less than 300 |
| 3 hr heated | less than 300 | less than 300 | less than 300 |

TABLE 9
E. Coli group (1 g of CFU)

| E. Coli group | Japanese | Japanese | Japanese |
|---|---|---|---|
| (1 g of CFU) | beef | pork | chicken |
| 1 hr heated | negative | negative | negative |
| 2 hr heated | negative | negative | negative |
| 3 hr heated | negative | negative | negative |

TABLE 10
E. Coli (1 g of CFU)

| E. Coli | Japanese | Japanese | Japanese |
|---|---|---|---|
| (1 g of CFU) | beef | pork | chicken |
| 1 hr heated | negative | negative | negative |
| 2 hr heated | negative | negative | negative |
| 3 hr heated | negative | negative | negative |

TABLE 11
Salmonella bacterium (1 g of CFU)

| Salmonella bacterium | Japanese | Japanese | Japanese |
|---|---|---|---|
| (1 g of CFU) | beef | pork | chicken |
| 1 hr heated | negative | negative | negative |
| 2 hr heated | negative | negative | negative |
| 3 hr heated | negative | negative | negative |

TABLE 12
Staphylococcus aureus (1 g of CFU)

| Staphylococcus aureus | Japanese | Japanese | Japanese |
|---|---|---|---|
| (1 g of CFU) | beef | pork | chicken |
| 1 hr heated | negative | negative | negative |
| 2 hr heated | negative | negative | negative |
| 3 hr heated | negative | negative | negative |

In the Embodiments, since heating time is comparatively short which is 1 hour through 1 hour and 15 minutes, excellent yield of handling meat can be obtained. For example, assuming that raw meat is 100%, yield is: 91% upon heating the meat for 1 hour; 83% upon heating the meat for 2 hours; and 79% upon heating the meat for 3 hours. In this way, cost for the handling can be substantially reduced.

### INDUSTRIAL APPLICABILITY

The method for preserving raw meat according to the present invention is available as an alternative of raw meat in the fields wherein meat is distributed and/or processed. For example, a butcher or the like can preserve the alternative processed by the method with a refrigerator before supplying thereof to his/her consumers.

1. A method for preserving raw meat, comprising:
(a) heating vacuum-packed raw meat at a temperature higher than 60 degrees Celsius and not higher than 65 degrees Celsius so as to surely avoid reaching a coagulation temperature of protein;
(b) further heating the raw meat for 1 hour to 1 hour and 15 minutes at a temperature condition of higher than 60 degrees Celsius and not higher than 65 degrees Celsius after a core temperature of the meat has exceeded 60 degrees Celsius;
(c) after the step (b) has been completed, rapidly cooling the meat so that the meat does not freeze; and
(d) lowering the core temperature of the meat to 4 degrees Celsius or less.

2. The method for preserving raw meat as defined in claim 1, wherein the raw meat is a meat block of 1 [kg] or more.

3. The method for preserving raw meat as defined in claim 1, further comprising:
(e) cutting the rapidly cooled meat into cut pieces of the meat; and
(f) packing the cut pieces of the meat by means of wrap.

4. The method for preserving raw meat as defined in claim 2, further comprising:
(e) cutting the rapidly cooled meat into cut pieces of the meat; and
(f) packing the cut pieces of the meat by means of wrap.
